(19) United States
(12) Patent Application Publication
(10) Pub. No.: US 2022/0051613 A1
(43) Pub. Date: Feb. 17, 2022

(54) PIXEL CIRCUIT, DISPLAY PANEL, DISPLAY APPARATUS AND CONTROL METHOD THEREOF

(71) Applicant: BOE TECHNOLOGY GROUP CO., LTD., Beijing (CN)

(72) Inventor: Yang YU, Beijing (CN)

(21) Appl. No.: 17/389,430

(22) Filed: Jul. 30, 2021

(30) Foreign Application Priority Data
Aug. 14, 2020 (CN) 202010816541.7

(51) Int. Cl. G09G 3/32

(52) U.S. Cl. CPC G09G 3/32; G09G 2300/0842; G09G 2310/0278

(57) ABSTRACT

A pixel circuit includes a driving sub-circuit, a data writing sub-circuit, a compensation sub-circuit and a storage sub-circuit. The data writing sub-circuit is configured to write a data signal into the second node in response to a first scan signal. The driving sub-circuit is configured to transmit the data signal and a compensation signal to the third node. The compensation sub-circuit is configured to write the data signal and the compensation signal into the first node in response to a second scan signal. The driving sub-circuit is further configured to output a driving signal to a light-emitting device at least according to a voltage of the first node. The storage sub-circuit is configured to store the data signal and the compensation signal, and includes first capacitors and switching element(s). Each switching element is configured to be turned on in response to a control signal, so that at least two first capacitors are connected in parallel.

### CROSS-REFERENCE TO RELATED APPLICATION

This application claims priority to Chinese Patent Application No. 202010816541.7, filed on Aug. 14, 2020, which is incorporated herein by reference in its entirety.

### TECHNICAL FIELD

The present disclosure relates to the field of display technologies, and in particular, to a pixel circuit, a display panel, a display apparatus and a control method thereof.

### BACKGROUND

With a technology development of thin film transistors (TFTs) with a low leakage current, and a continuous improvement of people's requirements for display effects, a display apparatus increasingly needs to operate at different refresh frequencies in a large span. For example, when a user is watching videos or playing games, a refresh frequency of the display apparatus may be set to a high value, e.g., 120 Hz, so as to ensure that dynamic pictures displayed by the display apparatus are smooth. When the user is watching static images or not using the display apparatus, the refresh frequency of the display apparatus may be set to a low value, e.g., 1 Hz, so as to reduce power consumption of the display apparatus.

### SUMMARY

In one aspect, a pixel circuit is provided. The pixel circuit includes a driving sub-circuit, a data writing sub-circuit, a compensation sub-circuit and a storage sub-circuit. The data writing sub-circuit is coupled to a first scan signal terminal, a data signal terminal and a second node. The data writing sub-circuit is configured to write a data signal received at the data signal terminal into the second node, in response to a first scan signal received at the first scan signal terminal. The driving sub-circuit is coupled to a first node, the second node and a third node. The driving sub-circuit is configured to transmit the data signal written into the second node and a compensation signal to the third node. The compensation sub-circuit is coupled to a second scan signal terminal, the first node and the third node. The compensation sub-circuit is configured to write the data signal and the compensation signal into the first node, in response to a second scan signal received at the second scan signal terminal. The driving sub-circuit is further configured to output a driving signal to a first electrode of a light-emitting device at least according to a voltage of the first node. The storage sub-circuit is configured to store the data signal and the compensation signal that are written into the first node. The storage sub-circuit includes a plurality of first capacitors and at least one switching element; each switching element is coupled to at least two first capacitors, and the switching element is further coupled to a control signal terminal; and the switching element is configured to be turned on in response to a control signal received at the control signal terminal, so that the at least two first capacitors coupled to the switching element are connected in parallel.

In some embodiments, the storage sub-circuit includes a first branch and at least one second branch coupled to the first branch. The first branch includes a first capacitor, and each second branch includes another first capacitor and a switching element that are connected in series.

In some embodiments, the at least one second branch includes N second branches; a first second branch of the N second branches and the first branch are connected in parallel, and an i-th second branch and the first capacitor in an (i-1)-th second branch are connected in parallel; N and i are both integers, N is greater than or equal to 2, and i is greater than or equal to 2 and less than or equal to N. Or, each second branch is connected in parallel with the first branch.

In some embodiments, the at least one switching element is an oxide thin film transistor or an a-Si thin film transistor.

In some embodiments, the driving sub-circuit includes a first transistor. A control electrode of the first transistor is coupled to the first node, a first electrode of the first transistor is coupled to the second node, and a second electrode of the first transistor is coupled to the third node.

In some embodiments, the data writing sub-circuit includes a second transistor. A control electrode of the second transistor is coupled to the first scan signal terminal, a first electrode of the second transistor is coupled to the data signal terminal, and a second electrode of the second transistor is coupled to the second node.

In some embodiments, the compensation sub-circuit includes a third transistor. A control electrode of the third transistor is coupled to the second scan signal terminal, a first electrode of the third transistor is coupled to the third node, and a second electrode of the third transistor is coupled to the first node.

In some embodiments, the pixel circuit further includes a first reset sub-circuit. The first reset sub-circuit is coupled to a first reset signal terminal, an initialization signal terminal and the first node. The first reset sub-circuit is configured to transmit an initialization signal received at the initialization signal terminal to the first node, in response to a first reset signal received at the first reset signal terminal.

In some embodiments, the first reset sub-circuit includes a fourth transistor. A control electrode of the fourth transistor is coupled to the first reset signal terminal, a first electrode of the fourth transistor is coupled to the initialization signal terminal, and a second electrode of the fourth transistor is coupled to the first node.

In some embodiments, the pixel circuit further includes a second reset sub-circuit. The second reset sub-circuit is coupled to a second reset signal terminal and the initialization signal terminal; the second reset sub-circuit is configured to be coupled to the first electrode of the light-emitting device. The second reset sub-circuit is further configured to transmit the initialization signal received at the initialization signal terminal to the first electrode of the light-emitting device, in response to a second reset signal received at the second reset signal terminal.

In some embodiments, the second reset sub-circuit includes a fifth transistor. A control electrode of the fifth transistor is coupled to the second reset signal terminal, a first electrode of the fifth transistor is coupled to the initialization signal terminal; and a second electrode of the fifth transistor is configured to be coupled to the first electrode of the light-emitting device.

In some embodiments, the pixel circuit further includes a first light-emitting control sub-circuit. The first light-emitting control sub-circuit is coupled to a light-emitting control terminal, the first voltage terminal and the driving sub-circuit; the first light-emitting control sub-circuit is configured to be coupled to the first electrode of the light-emitting device. The first light-emitting control sub-circuit is further configured to be turned on in response to a light-emitting control signal received at the light-emitting control terminal, so that the driving sub-circuit is communicated with the first voltage terminal and the first electrode of the light emitting device.

In some embodiments, the first light-emitting control sub-circuit includes a sixth transistor and a seventh transistor, A control electrode of the sixth transistor is coupled to the light-emitting control terminal, a first electrode of the sixth transistor is coupled to the first voltage terminal, and a second electrode of the sixth transistor is coupled to the driving sub-circuit. A control electrode of the seventh transistor is coupled to the light-emitting control terminal, a first electrode of the seventh transistor is coupled to the driving sub-circuit, and a second electrode of the seventh transistor is configured to be coupled to the first electrode of the light-emitting device.

In some embodiments, the pixel circuit further includes a second light-emitting control sub-circuit and a second capacitor. A first terminal of the second capacitor is coupled to the first node, and a second terminal of the second capacitor is coupled to the second light-emitting control sub-circuit. The second light-emitting control sub-circuit is coupled to the first voltage terminal and the light-emitting control terminal. The second light-emitting control sub-circuit is configured to transmit the first voltage of the first voltage terminal to the second terminal of the second capacitor, in response to the light-emitting control signal received at the light-emitting control terminal.

In some embodiments, the second light-emitting control sub-circuit includes an eighth transistor. A control electrode of the eighth transistor is coupled to the light-emitting control terminal, a first electrode of the eighth transistor is coupled to the first voltage terminal, and a second electrode of the eighth transistor is coupled to the second terminal of the second capacitor.

In some embodiments, the pixel circuit further includes a third reset sub-circuit. The third reset sub-circuit is coupled to a third reset signal terminal, an initialization signal terminal and the second terminal of the second capacitor. The third reset sub-circuit is configured to transmit an initialization signal received at the initialization signal terminal to the second terminal of the second capacitor, in response to a third reset signal received at the third reset signal terminal.

In some embodiments, the third reset sub-circuit includes a ninth transistor. A control electrode of the ninth transistor is coupled to the third reset signal terminal, a first electrode of the ninth transistor is coupled to the initialization signal terminal, and a second electrode of the ninth transistor is coupled to the second terminal of the second capacitor.

In another aspect, a display panel is provided. The display panel includes a plurality of pixel circuits as described in any of the above embodiments and a plurality of light-emitting devices. A first electrode of a light-emitting device of the plurality of light-emitting devices is coupled to the pixel circuit, and a second electrode of the light-emitting device is coupled to a second voltage terminal.

In yet another aspect, a display apparatus is provided. The display apparatus includes the display panel as described in the above embodiment and a controller coupled to the display panel. The controller is configured to output at least one control signal to at least one control signal terminal coupled to the at least one switching element in the storage sub-circuit in the pixel circuit according to a refresh frequency of the display panel, so as to control the at least one switching element in the storage sub-circuit to be turned on and off.

In yet another aspect; a control method of control a display apparatus is provided. The display apparatus is the display apparatus as described in the above embodiments. The control method includes: obtaining; by the controller, the refresh frequency of the display panel; and outputing, by the controller the at least one control signal to the at least one control signal terminal coupled to the at least one switching element in the storage sub-circuit, according to the refresh frequency of the display panel.

### BRIEF DESCRIPTION OF THE DRAWINGS

In order to describe technical solutions in the present disclosure more clearly, accompanying drawings to be used in some embodiments of the present disclosure will be introduced briefly. However; the accompanying drawings to be described below are merely accompanying drawings of some embodiments of the present disclosure, and a person of ordinary skill in the art may obtain other drawings according to these drawings. In addition, the accompanying drawings in the following description may be regarded as schematic diagrams; and are not limitations on actual dimensions of products, actual processes of methods and actual timings of signals involved in the embodiments of the present disclosure.

FIG. 1 is a schematic diagram of a display apparatus; in accordance with some embodiments;

FIG. 2A is a schematic diagram of another display apparatus, in accordance with some embodiments;

FIG. 2B is a schematic diagram of a display panel, in accordance with some embodiments;

FIG. 3A is a block diagram of a pixel circuit, in accordance with some embodiments;

FIG. 3B is a block diagram of another pixel circuit, in accordance with some embodiments;

FIG. 4 is a schematic diagram of a pixel circuit, in accordance with some embodiments;

FIG. 5 is a schematic diagram of another pixel circuit, in accordance with some embodiments;

FIG. 6 is a schematic diagram of yet another pixel circuit, in accordance with some embodiments;

FIG. 7 is a schematic diagram of yet another pixel circuit, in accordance with some embodiments;

FIG. 8A is a schematic diagram of yet another pixel circuit, in accordance with some embodiments;

FIG. 8B is a schematic diagram of yet another pixel circuit, in accordance with some embodiments;

FIG. 80 is a schematic diagram of yet another pixel circuit, in accordance with some embodiments;

FIG. 9A is a circuit diagram of a pixel circuit; in accordance with some embodiments;

FIG. 9B is a circuit diagram of another pixel circuit, in accordance with some embodiments;

FIG. 90 is a circuit diagram of yet another pixel circuit, in accordance with some embodiments;

FIG. 10 is a signal timing diagram of a pixel circuit, in accordance with some embodiments;

FIG. 11A is a schematic diagram of simulation results of pixel circuits in Example 1 and Example 2 at a high frequency;

FIG. 11B is another schematic diagram of simulation results of pixel circuits in Example 1 and Example 2 at a high frequency;

FIG. 11C is yet another schematic diagram of simulation results of pixel circuits in Example 1 and Example 2 at a low frequency;

FIG. 11D is yet another schematic diagram of simulation results of pixel circuits in Example 1 and Example 2 at a low frequency; and

FIG. 12 is a circuit diagram of yet another pixel circuit; in accordance with some embodiments.

### DETAILED DESCRIPTION

Technical solutions in some embodiments of the present disclosure will be described clearly and completely below with reference to the accompanying drawings. However, the described embodiments are merely some but not all embodiments of the present disclosure. All other embodiments obtained on a basis of the embodiments of the present disclosure by a person of ordinary skill in the art shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to.” In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials; or characteristics may be included in any one or more embodiments or examples in any suitable manner.

Hereinafter, the terms “first” and “second” are only used for descriptive purposes, and are not to be construed as indicating or implying relative importance or implicitly indicating the number of indicated technical features. Thus, a feature defined as “first” or “second” may explicitly or implicitly include one or more of the features. In the description of the embodiments of the present disclosure, the term “a plurality of/the plurality of” means two or more unless otherwise specified.

In the description of some embodiments, terms “coupled” and “connected” and their derivatives may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” or “connected” may also mean that two or more components are not in direct contact with each other, but still cooperate or interact with each other. The embodiments disclosed herein are not necessarily limited to the contents herein.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of “configured to” indicates an open and inclusive meaning, which does not exclude apparatuses that are configured to perform additional tasks or steps.

Some embodiments of the present disclosure provide a display apparatus. The display apparatus may be a mobile phone, a tablet computer, a personal digital assistant (FDA), a vehicle-mounted computer, or the like. Some embodiments of the present disclosure do not limit specific form of the display apparatus.

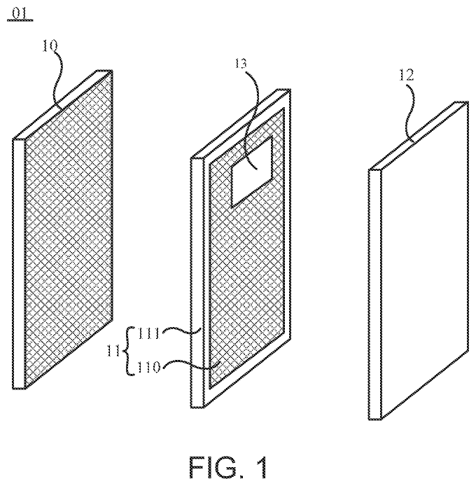

In some embodiments, as shown in FIG. 1, the display apparatus 01 includes a display panel 10. In some examples, the display panel 10 is a self-luminous display panel. The self-luminous display panel may be an organic light-emitting diode (OLED) display panel, a quantum dot light-emitting diode (QLED) display panel, a micro light-emitting diode (Micro LED) display panel, or a mini light-emitting diode (Mini LED) display panel.

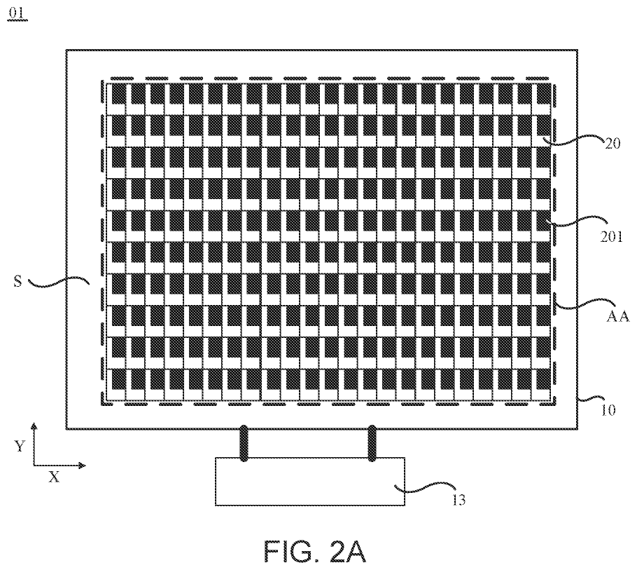

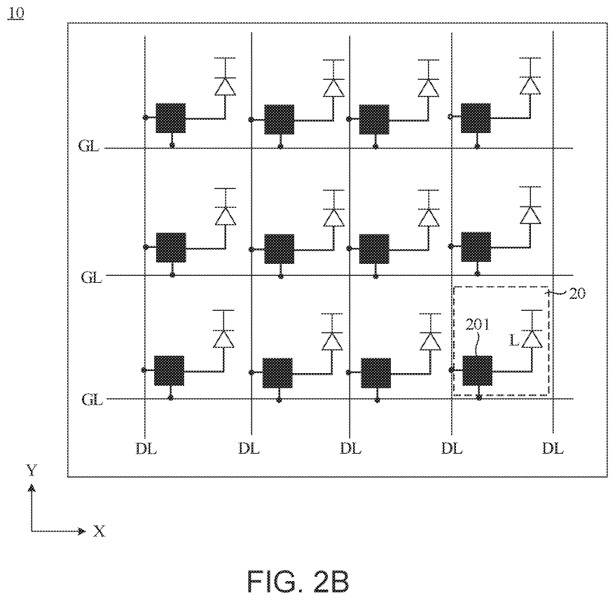

In some embodiments, as shown in FIG. 2, the display panel 10 has a display area AA and a peripheral area S located at least one side of the display area AA, In some examples, the peripheral area S surrounds the display area AA.

As shown in FIG. 2A, the display panel 10 includes a plurality of sub-pixels 20 located in the display area AA. For example, the plurality of sub-pixels 20 are arranged in an array. Sub-pixels 20 arranged in a line in a first direction X are referred to as sub-pixels 20 in a same row. Sub-pixels 20 arranged in a line in a second direction Y are referred to as sub-pixels 20 in a same column. The first direction X crosses the second direction Y. For example, the first direction X is perpendicular to the second direction Y.

In some embodiments, as shown in FIG. 2B, each sub-pixel 20 includes a pixel circuit 201 and a light-emitting device L coupled to the pixel circuit 201. The pixel circuit 201 is configured to drive the light-emitting device L to emit light.

It will be noted that a person skilled in the art can select the light-emitting device L according to actual needs, which is not specifically limited herein. For example, the light-emitting device L is an OLED, a Micro LED, a Mini LED or a QLED. For another example, the light-emitting device L can emit red light, green light, blue light, or white light.

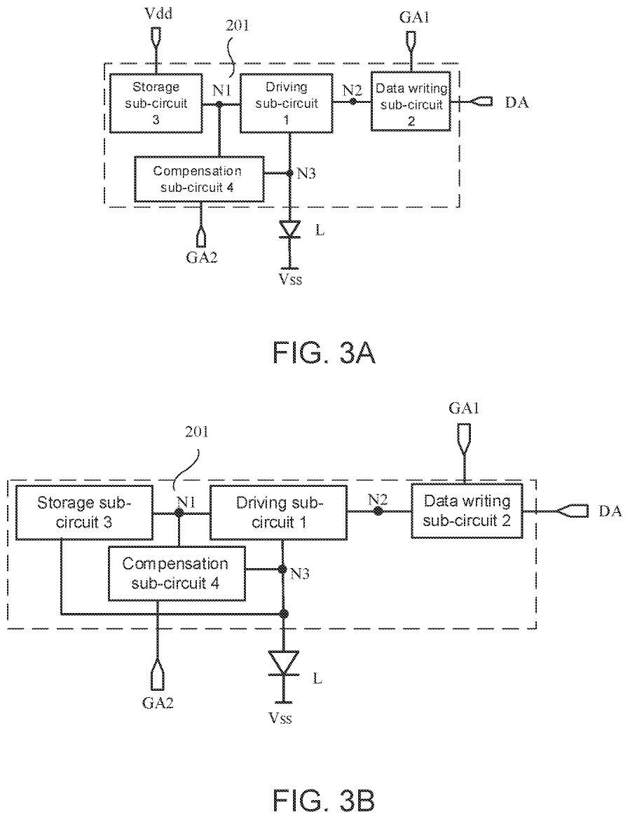

As shown in FIGS. 3A and 3B, the pixel circuit 201 provided in some embodiments of the present disclosure includes a driving sub-circuit 1, a data writing sub-circuit 2, a storage sub-circuit 3 and a compensation sub-circuit 4.

As shown in FIGS. 3A and 3B, the driving sub-circuit 1 is coupled to a first node N1, a second node N2 and a third node N3. The data writing sub-circuit 2 is coupled to a first scan signal terminal GA1, a data signal terminal DA, and the second node N2. The compensation sub-circuit 4 is coupled to a second scan signal terminal GA2, the first node N1 and the third node N3.

The data writing sub-circuit 2 is configured to write a data signal received at the data signal terminal DA into the second node N2, in response to a first scan signal received at the first scan signal terminal GA1.

The driving sub-circuit 1 is configured to transmit the data signal written into the second node N2 and a compensation signal to the third node N3.

The compensation sub-circuit 4 is configured to write the data signal and the compensation signal into the first node N1, in response to a second scan signal received at the second scan signal terminal GA2.

The driving sub-circuit 1 is further configured to output a driving signal at least according to a voltage of the first node N1.

The compensation signal written into the first node N1 can realize the compensation of the driving sub-circuit 1, so as to avoid that driving signals output by the driving sub-circuits 1 in different sub-pixels 20 are different due to factors such as manufacturing process in a case where the data signal is the same. For example, the driving sub-circuit 1 includes a driving transistor, and the compensation signal is a threshold voltage compensation signal that is used to compensate for the threshold voltage of the driving transistor.

The light-emitting device L emits light according to the driving signal, so that the sub-pixel 20 including the pixel circuit 201 and the light-emitting device L coupled to the pixel circuit 201 realizes gray scale display.

For example, referring to FIGS. 3A and 3B, a first electrode of the light-emitting device L is coupled to the pixel circuit 201, and a second electrode of the light-emitting device L is coupled to a second voltage terminal Vss.

The storage sub-circuit 3 is configured to store the compensation signal and the data signal that are written into the first node N1.

In a data writing period, the storage sub-circuit 3 stores the data signal and the compensation signal that are written into the first node N1, and in a light-emitting period, the storage sub-circuit 3 controls the voltage of the first node N1 according to the stored data signal and the compensation signal, so as to control the driving signal output by the driving sub-circuit 1.

In some examples, as shown in FIG. 3A, the storage sub-circuit 3 is coupled to the first node N1 and a first voltage terminal Vdd. In some other examples, as shown in FIG. 3B, the storage sub-circuit 3 is coupled to the first node N1 and the first electrode of the light-emitting device L.

In some examples, the first voltage terminal Vdd is configured to provide a first voltage. The first voltage may be a high-level voltage, such as a direct current high-level voltage.

In some examples, the second voltage terminal Vss is configured to provide a second voltage. The second voltage may be a low-level voltage, such as a direct current low-level voltage. For example, the second voltage terminal is grounded.

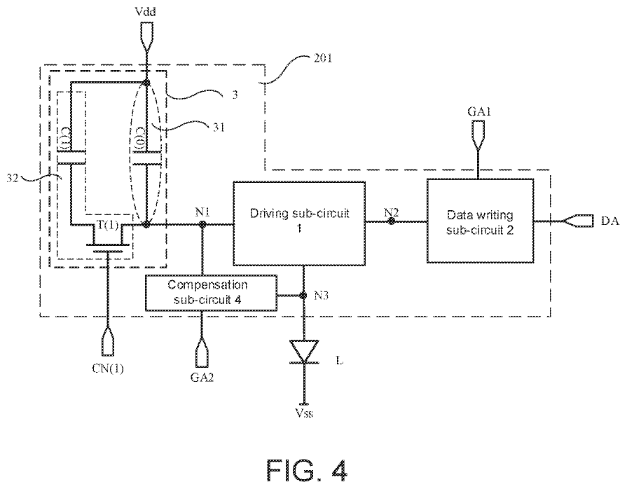

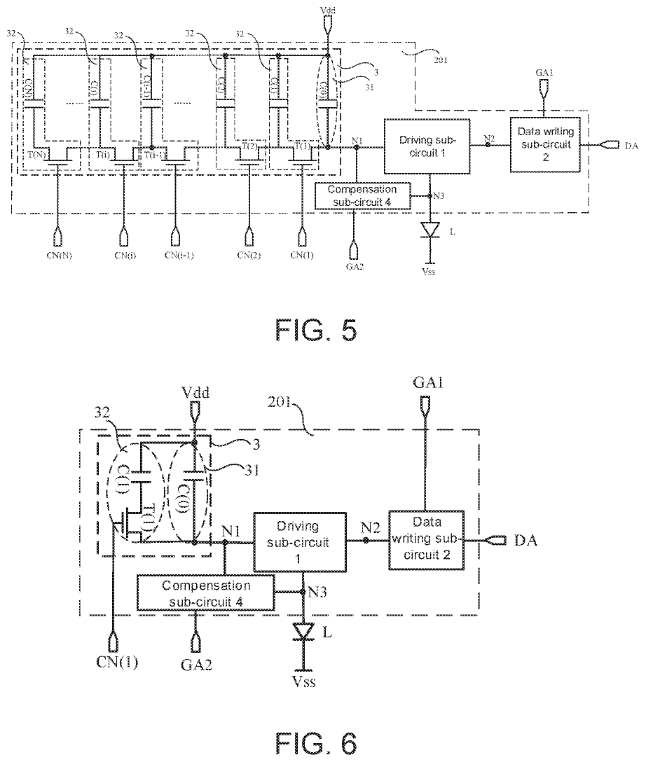

Referring to FIGS. 4 and 5, the storage sub-circuit 3 includes a plurality of first capacitors C (e.g., two first capacitors C(0) and C(1) shown in FIG. 4) and at least one switching element T (e.g., a switching element T(1) shown in FIG. 4). Each switching element T is coupled with at least two first capacitors C. The switching element T is further coupled to a control signal terminal ON (e.g., the switching element T(1) shown in FIG. 4 is coupled to the control signal terminal CN(1)). The switching element T is configured to be tuned on in response to a control signal received at the control signal terminal CN, so that the at least two first capacitors C coupled to the switching element T are connected in parallel.

It will be noted that, the number of the first capacitors C and the number of the switching element(s) T are not limited in the embodiments of the present disclosure, and may be set according to actual needs. For example, the number of first capacitors C is two, and the number of switching element(s) is one. For another example, the number of first capacitors C is three, and the number of switching elements is two. For yet another example, the number of first capacitors C is K, and the number of switching elements is K-1. K is an integer greater than or equal to 4.

In some examples, the switching element T is a thin film transistor (TFT). For example, the switching element T is an oxide thin film transistor (Oxide TFT), an a-Si thin film transistor (a-Si TFT), a low temperature poly-silicon thin film transistor (LTPS TFT), or a low temperature polycrystalline oxide thin film transistor (LTPO TFT). In some other examples, the switching element T is a metal oxide semiconductor thin film transistor (MOS TFT).

For example, the switching element T is an oxide thin film transistor or an a-Si thin film transistor. Since the oxide thin film transistor and the a-Si thin film transistor have a small leakage current, it is conducive to maintaining the voltage of the signal stored in the storage sub-circuit 3 in the light-emitting period.

At least one switching element T is turned on in response to control signal(s) received at corresponding control signal terminal(s) ON, so that first capacitors C coupled to the turned-on switching element(s) T are connected in parallel. In this case, each of the first capacitors C connected in parallel may form a conductive path with the first node N1, and the first capacitors C connected in parallel store the data signal and the compensation signal written into the first node N1. A capacitance of the storage sub-circuit 3 is equal to a sum of capacitances of the first capacitors C connected in the parallel.

Referring to FIG. 4, in a case where the at least one switching element T in the storage sub-circuit 3 includes the switching element T(1), the switching element T(1) is turned on in response to a control signal received at the control signal terminal CN(1), and two first capacitors coupled to the switching element T(1), i.e., the first capacitor C(0) and the first capacitor C(1), are connected in parallel. In this way, the capacitance Cs of the storage sub-circuit 3 is a sum of a capacitance C₀ of the first capacitor C(0) and a capacitance C₁ of the first capacitor C(1) (i.e., Cs=C₀+C₁).

It will be noted that, when the pixel circuit 201 is operating, only one of the first capacitors C in the storage sub-circuit 3 operates, or at least two first capacitors C connected in parallel in the storage sub-circuit 3 operate, which may be controlled by controller according to actual needs.

In some embodiments, the at least one switching element T includes a plurality of switching elements T. In some examples, control electrodes of the plurality of switching elements T are coupled to different control signal terminals ON. In this case, control signals received by the control electrodes of the plurality of switching elements T are different or the same, and each switching element T is independently controlled to be turned on or off. In some other examples, control electrodes of the plurality of switching elements T are coupled to a same control signal terminal ON. In this case, the control electrodes of the plurality of switching elements T receive a same control signal, and the plurality of switching elements T are simultaneously controlled to be turned on or off. In yet some other examples, control electrodes of at least two of the plurality of switching elements T are coupled to a same control signal terminal ON. In this case, the control electrodes of the at least two of the plurality of switching elements T receive a same control signal, and the at least two of the switching elements T are simultaneously controlled to be turned on or off.

In some embodiments, as shown in FIGS. 4 and 5, the storage sub-circuit 3 includes a first branch 31 and at least one second branch 32 coupled to the first branch 31.

In some embodiments, as shown in FIGS. 4 and 5, the first branch 31 includes a first capacitor C, and each second branch 32 includes another first capacitor C and a switching element T that are connected in series.

In some examples, as shown in FIG. 4, a terminal of the first branch 31 is coupled to the first node N1, and another terminal of the first branch 31 is coupled to the first voltage terminal Vdd. The at least one second branch 32 includes one second branch 32. A terminal of the second branch 32 is coupled to the terminal of the first branch 31, i.e., coupled to the first node N1, and another terminal of the second branch 32 is coupled to the another terminal of the first branch 31, i.e., coupled to the first voltage terminal Vdd. That is, the first branch 31 and the second branch 32 are connected in parallel.

For example, as shown in FIG. 4, a terminal of the first capacitor C(0) in the first branch 31 is coupled to the first node N1, and another terminal of the first capacitor C(0) in the first branch 31 is coupled to the first voltage terminal Vdd. A terminal of the first capacitor C(1) in the second branch 32 is coupled to a second electrode of the switching element T(1) in the second branch 32. A first electrode of the switching element T(1) in the second branch 32 is coupled to the first node N1, and the control electrode of the switching element T(1) in the second branch 32 is coupled to the control signal terminal CN(1). Another terminal of the first capacitor C(1) in the second branch 32 is coupled to the first voltage terminal Vdd.

In this case, the switching element T(1) in the second branch 32 is turned on in response to the control signal received at the control signal terminal CN(1), so that the first capacitor C(1) in the second branch 32 and the first capacitor C(0) in the first branch 31 are connected in parallel. As a result, the first capacitor C(0) in the first branch 31 and the first capacitor C(1) in the second branch 32 store the data signal and the compensation signal that are written to the first node N1, thereby improving storage capacity of the storage sub-circuit 3.

In some other examples, as shown in FIG. 5, a terminal of the first branch 31 is coupled to the first node N1, and another terminal of the first branch 31 is coupled to the first voltage terminal Vdd. The at least one second branch 32 includes N second branches 32.

A first second branch 32 of the N second branches 32 and the first branch 31 are connected in parallel, and an i-th second branch 32 and the first capacitor C in an (i−1)-th second branch 32 are connected in parallel. N and i are both integers, N is greater than or equal to 2, and i is greater than or equal to 2 and less than or equal to N.

That is, two terminals of the first second branch 32 are respectively coupled to two terminals of the first capacitor C in the first branch 31, and two terminals of the i-th second branch 32 are respectively coupled to two terminals of the first capacitor C in the (i−1)-th second branch 32.

For example, referring to FIG. 5, a terminal of the first capacitor C(0) in the first branch 31 is coupled to the first node N1, and another terminal of the first capacitor C(0) in the first branch 31 is coupled to the first voltage terminal Vdd. A terminal of the first capacitor C(1) in the first second branch 32 is coupled to a second electrode of the switching element T(1) in the first second branch 32. A first electrode of the switching element T(1) in the first second branch 32 is coupled to the first node N1, and the control electrode of the switching element T(1) in the first second branch 32 is coupled to the control signal terminal CN(1). Another terminal of the first capacitor C(1) in the first second branch 32 is coupled to the first voltage terminal Vdd.

Moreover, a terminal of the first capacitor C(2) in the second second branch 32 is coupled to a second electrode of the switching element T(2) in the second second branch 32. A first electrode of the switching element T(2) in the second second branch 32 is coupled to the terminal of the first capacitor C(1) in the first second branch 32, and the control electrode of the switching element T(2) in the second second branch 32 is coupled to the control signal terminal CN(2). Another terminal of the first capacitor C(2) in the second second branch 32 is coupled to the first voltage terminal Vdd. A terminal of the first capacitor C(i) in the i-th second branch 32 is coupled to a second electrode of the switching element T(i) in the i-th second branch 32. A first electrode of the switching element T(i) in the i-th second branch 32 is coupled to the terminal of the first capacitor C(i-1) in the (i-1)-th second branch 32, and the control electrode of the switching element T(i) in the i-th second branch 32 is coupled to the control signal terminal CN(i). Another terminal of the first capacitor C(i) in the i-th second branch 32 is coupled to the first voltage terminal Vdd. A terminal of the first capacitor C(N) in the N-th second branch 32 is coupled to a second electrode of the switching element T(N) in the N-th second branch 32. A first electrode of the switching element T(N) in the N-th second branch 32 is coupled to the terminal of the first capacitor C(N-1) in the (N-1)-th second branch 32, and the control electrode of the switching element T(N) in the N-th second branch 32 is coupled to the control signal terminal CN(N). Another terminal of the first capacitor C(N) in the N-th second branch 32 is coupled to the first voltage terminal Vdd.

The switching element T(1) in the first second branch 32 is turned on, and the first capacitor C(1) in the first second branch 32 and the first capacitor C(0) in a first branch 31 form a conductive path. The switching element T(i) in the i-th second branch 32 is turned on, and the first capacitor C(i) in the i-th second branch 32 and the first capacitor C(i-1) in the (i-1)-th second branch 32 form a conductive path.

Referring to FIG. 5, if the first capacitor C in the i-th second branch 32 needs to form a conductive path with the first branch 31, all switching elements T in the first second branch 32 to the i-th second branch 32 need to be turned on. In this way, the first capacitor C in the first branch 31 and all the first capacitors C in the first second branch 32 to the i-th second branch 32 are connected in parallel. Therefore, the capacitance of the storage sub-circuit 3 is a sum of the capacitance of the first capacitor C in the first branch 31 and capacitances of the first capacitors C in the first second branch 32 to the i-th second branch 32.

For example, as shown in FIG. 5, when the switching element T(1) and the switching element T(2) are turned on, the first capacitor C(1) in the first second branch 32 and the first capacitor C(2) in the second second branch 32 forms a conductive path with the first capacitor C(0) in the first branch 31. In this case, the first capacitor C(2), the first capacitor C(1) and the first capacitor C(0) are connected in parallel, and the capacitance of the storage sub-circuit 3 is a sum of capacitances of the first capacitor C(2), the first capacitor C(1) and the first capacitor C(0).

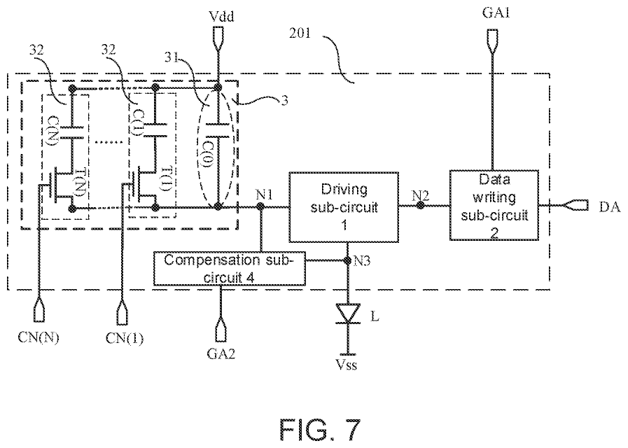

In some other embodiments, as shown in FIGS. 6 and 7, the storage sub-circuit 3 includes a first branch 31 and at least one second branch 32 coupled to the first branch 31. Each second branch 32 and the first branch 31 are connected in parallel. That is, two terminals of each second branch 32 are connected to two terminals of the first branch 31, respectively.

As shown in FIGS. 6 and 7, the first branch 31 includes a first capacitor C, and the second branch 32 includes another first capacitor C and a switching element T that are connected in series.

For example, as shown in FIG. 6, the storage sub-circuit 3 includes one second branch 32, For example, a terminal of the first capacitor C(0) in the first branch 31 is coupled to the first node N1, and another terminal of the first capacitor C(0) in the first branch 31 is coupled to the first voltage terminal Vdd. A terminal of the first capacitor C(1) in the second branch 32 is coupled to a second eletrode of the switching element T(1) in the second branch 32, and a first electrode of the switching element T(1) in the second branch 32 is coupled to the first node N1. Another terminal of the first capacitor C(1) in the second branch 32 is coupled to the first voltage terminal Vdd.

For another example, as shown in FIG. 7, the storage sub-circuit 3 includes a plurality of second branches 32. Two terminals of a series structure of the first capacitor C and the switching element T in each second branch 32 are coupled to two terminals of the first capacitor C in the first branch 31, respectively.

In this case, as long as the switching element T in any second branch 32 is turned on, the first capacitor C in the second branch 32 and the first capacitor C in the first branch 31 are connected in parallel and form a conductive path. That is, each second branch 32 may be independently controlled to form a conductive path with the first branch 31. The capacitance of the storage sub-circuit 3 is a sum of the capacitance of the first capacitor C in the first branch 31 and capacitance(s) of the first capacitor(s) C in the second branch(es) 32 each including the turn-on switching element T.

It will be noted that, the magnitude of the capacitance of the storage sub-circuit 3 is related to the number of first capacitors C that are connected in parallel and a capacitance of of each first capacitor C. For example, the capacitance of the storage sub-circuit 3 may be a capacitance of one first capacitor C, or a sum of capacitances of two or more first capacitors C. The number of the second branches 32 in the storage sub-circuit 3 is not limited in the embodiments of the present disclosure, and may be selected according to actual needs. In addition, a person skilled in the art may select the capacitance of each first capacitor C in the storage sub-circuit 3 according to actual needs, which is not limited herein. For example, the capacitances of the first capacitors may be the same or different, or may not be exactly the same.

In the above description, the first branch 31 and the second branch 32 are coupled to the first node N1 and the first voltage terminal Vdd. That is, the terminal of the first branch 31 and the terminal of the second branch 32 are coupled to the first node N1, and the another terminal of the first branch 31 and the another terminal of the second branch 32 are coupled to the first voltage terminal Vdd. In some embodiments, the first branch 31 and the second branch 32 may also be coupled to the first node N1 and the first electrod of the light-emitting device L. That is, the terminal of the first branch 31 and the terminal of the second branch 32 are coupled to the first node N1, and the another terminal of the first branch 31 and the another terminal of the second branch 32 are coupled to the first electrod of the light-emitting device L.

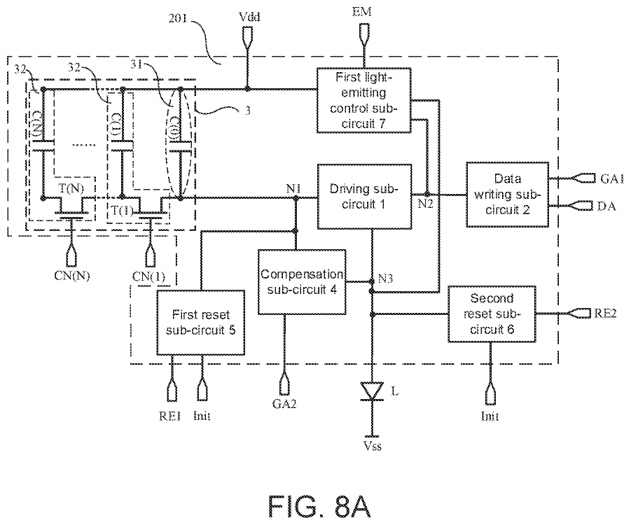

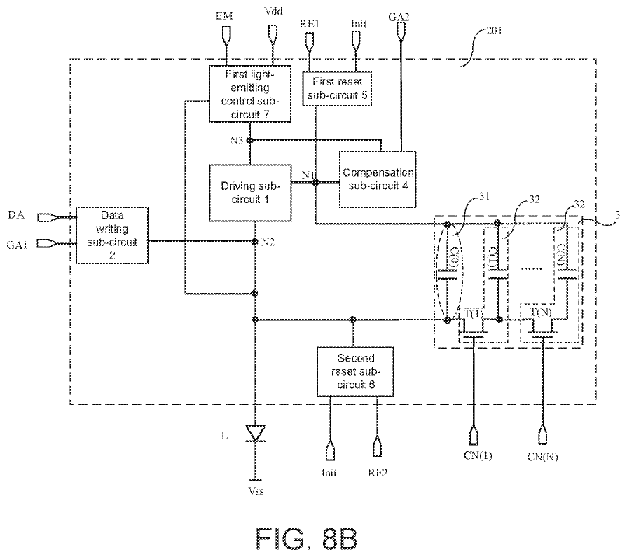

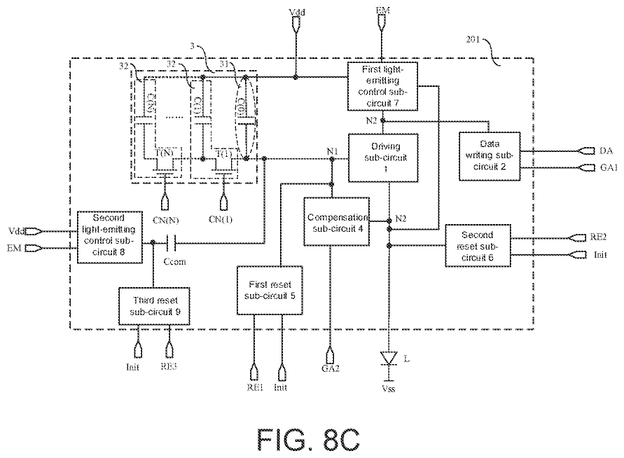

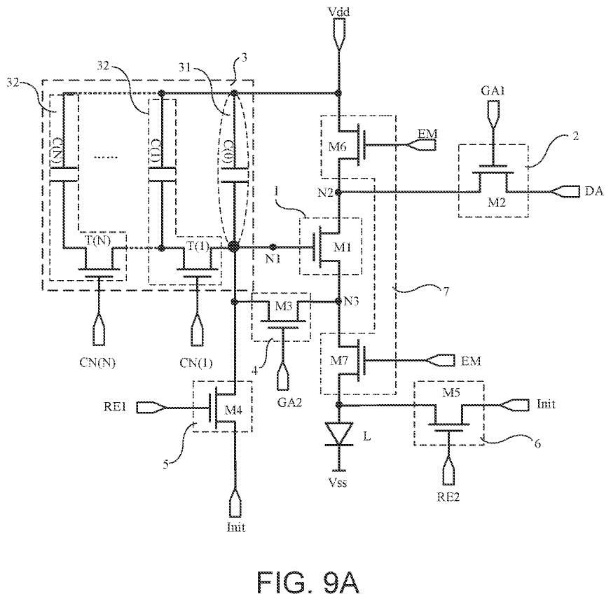

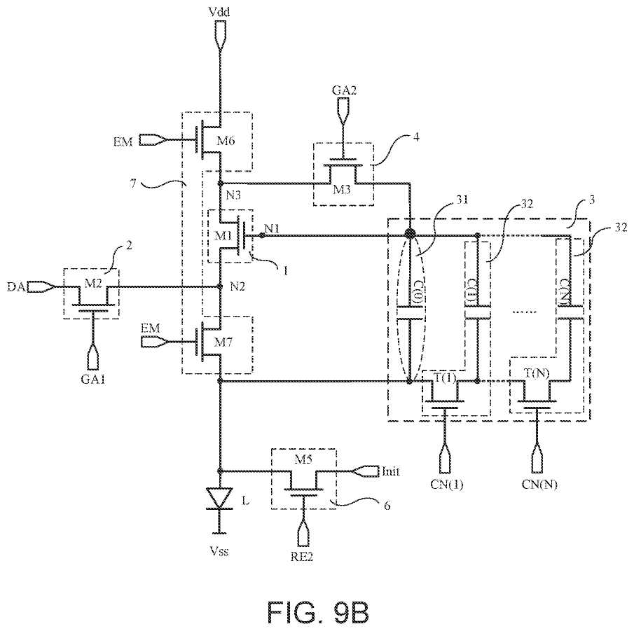

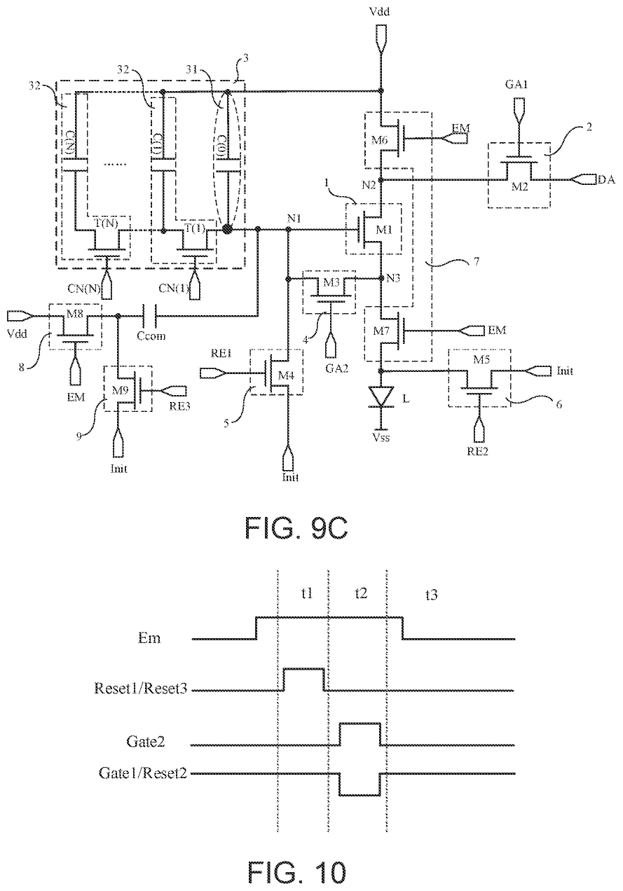

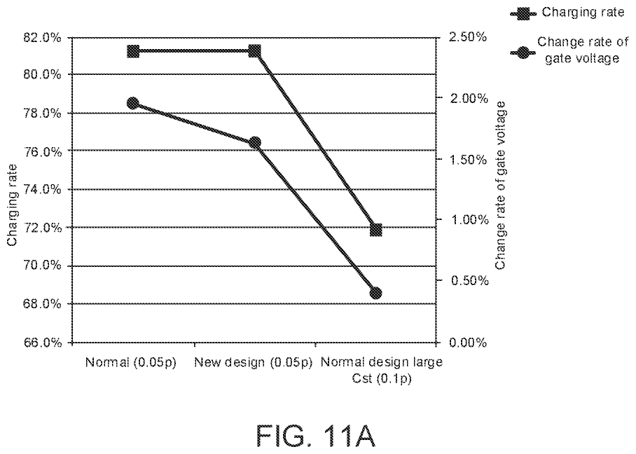

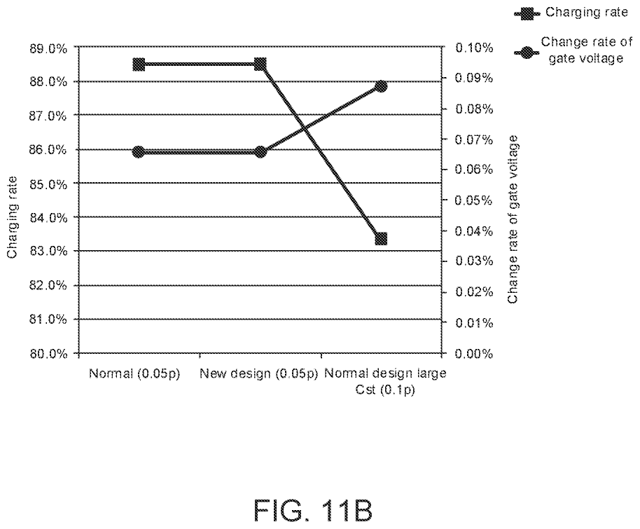

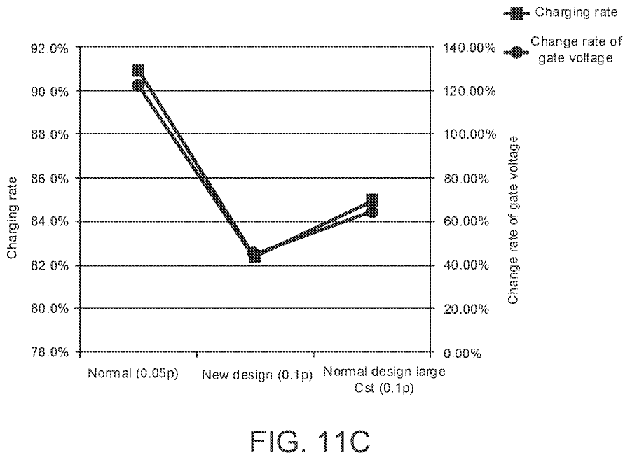

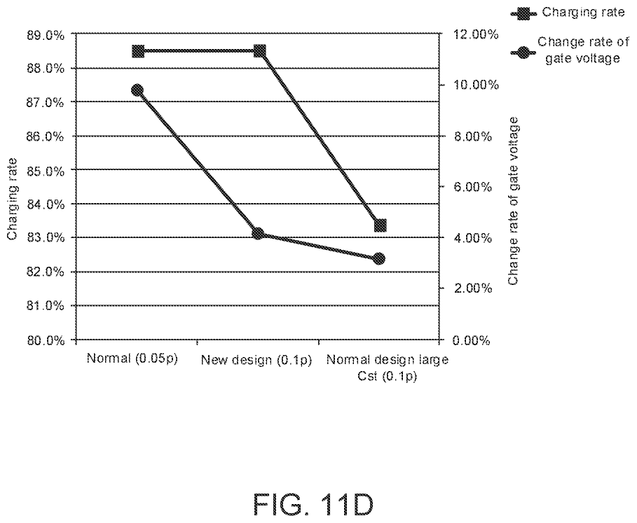

In some embodiments, as shown in FIGS. 8A and 8C, the pixel circuit 201 further includes a first reset sub-circuit 5. The first reset sub-circuit 5 is coupled to a first reset signal terminal RE1, an initialization signal terminal Init, and the first node N1. The first reset sub-circuit 5 is configured to transmit an initialization signal received at the initialization signal terminal Init to the first node N1, in response to a first reset signal received at the first reset signal terminal RE1. In this case, the voltage of the first node N1 may be initialized in a reset period, and it is possible to prevent a residual signal of a previous frame from affecting a display effect of a current frame.

In some embodiments, as shown in FIGS. 8A to 8C, the pixel circuit 201 further includes a second reset sub-circuit 6. The second reset sub-circuit 6 is coupled to a second reset signal terminal RE2 and the initialization signal terminal Init, and the second reset sub-circuit 6 is configured to be coupled to the first electrode of the light-emitting device L. The second reset sub-circuit 6 is further configured to transmit the initialization signal received at the initialization signal terminal Init to the first electrode of the light-emitting device L to initialize the first electrode of the light-emitting device L, in response to a second reset signal received at the second reset signal terminal RE2. In this case, it is possible to prevent the residual signal of the previous frame from affecting the display effect of the current frame.

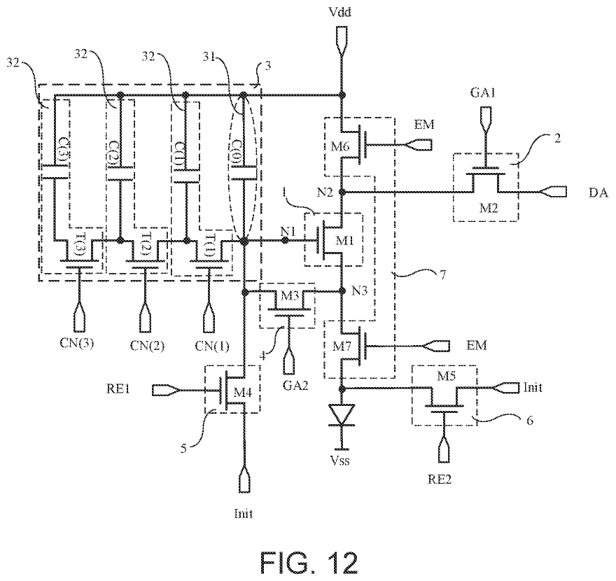

In some embodiments, as shown in FIGS. 8A to 80, the pixel circuit 201 further includes a first light-emitting control sub-circuit 7. The first light-emitting control sub-circuit 7 is coupled to a light-emitting control terminal EM, the first voltage terminal Vdd, and the driving sub-circuit 1, and the first light-emitting control sub-circuit 7 is configured to be coupled to the first electrode of the light-emitting device L. The first light-emitting control sub-circuit 7 is further configured to be turned on in response to a light-emitting control signal received at the light-emitting control terminal EM, so that the driving sub-circuit 1 is communicated with the first voltage terminal and the first electrode of the light emitting device L.

In some examples, the first light-emitting control sub-circuit 7 is coupled to the second node N2 and the third node N3 that are coupled to the driving sub-circuit 1. In this case, the first light-emitting control sub-circuit 7 transmits a first voltage of the first voltage terminal Vdd to the second node N2 in response to the light-emitting control signal received at the light-emitting control terminal EM, and then the first light-emitting control sub-circuit 7 transmits the driving signal output by the driving sub-circuit 1 to the first electrode of the light-emitting device L through the third node N3 in response to the light-emitting control signal received at the light-emitting control terminal EM. For example, the first light-emitting control sub-circuit 7 transmits the first voltage of the first voltage terminal Vdd to the second node N2, and then transmits the driving signal output by the driving sub-circuit 1 according to the first voltage and the voltage of the first node N1 to the first electrode of the light-emitting device L though the third node N3.

That is, in the light-emitting period, the first light-emitting control sub-circuit 7 is turned on in response to the light-emitting control signal received at the light-emitting control terminal EM, so as to make the first voltage terminal Vdd, the driving sub-circuit 1 and the light-emitting device L form a conductive path to drive the light-emitting device L to emit light.

In some embodiments, as shown in FIG. 8C, the pixel circuit 201 further includes a second light-emitting control sub-circuit 8 and a second capacitor Ccom. A first terminal of the second capacitor Ccom is coupled to the first node N1, and a second terminal of the second capacitor Ccom is coupled to the second light-emitting control sub-circuit 8. The second light-emitting control sub-circuit 8 is further coupled to the first voltage terminal Vdd and the light-emitting control terminal EM. The second light-emitting control sub-circuit 8 is configured to transmit the first voltage of the first voltage terminal Vdd to the second terminal of the second capacitor Ccom, in response to the light-emitting control signal received at the light-emitting control terminal EM. In this case, due to coupling effect of the second capacitor Ccom, a voltage of the first terminal of the second capacitor Ccom (i.e., the voltage of the first node N1) is a sum of the first voltage, a voltage of the data signal and a voltage of the compensation signal.

In some embodiments, as shown in FIG. 80, the pixel circuit 201 further includes a third reset sub-circuit 9. The third reset sub-circuit 9 is coupled to a third reset signal terminal RE3, the initialization signal terminal Init and the second terminal of the second capacitor Ccom. The third reset sub-circuit 9 is configured to transmit the initialization signal received at the initialization signal terminal Init to the second terminal of the second capacitor Ccom to initialize the second terminal of the second capacitor Ccom, in response to a third reset signal received at the third reset signal terminal RE3. In this case, it is possible to prevent the residual signal of the previous frame from affecting the display effect of the current frame.

For example, the third reset signal of the third reset signal terminal RE3 is the same as the first reset signal of the first reset signal terminal RE1.

In some embodiments, as shown in FIGS. 9A, 9B, and 9C the driving sub-circuit 1 includes a first transistor M1, and the first transistor M1 is the driving transistor. A control electrode of the first transistor M1 is coupled to the first node N1, a first electrode of the first transistor M1 is coupled to the second node N2, and a second electrode of the first transistor M1 is coupled to the third node N3. For example, as shown in FIGS. 9A and 9C, the first transistor M1 is a P-type transistor. For example, as shown in FIG. 9B, the first transistor M1 is an N-type transistor.

In some embodiments, as shown in FIGS. 9A, 9B, and 9C, the data writing sub-circuit 2 includes a second transistor M2. A control electrode of the second transistor M2 is coupled to the first scan signal terminal GA1, a first electrode of the second transistor M2 is coupled to the data voltage terminal DA, and a second electrode of the second transistor M2 is coupled to the second node N2.

In some embodiments, as shown in FIGS. 9A, 9B, and 90, the compensation sub-circuit 4 includes a third transistor M3. A control electrode of the third transistor M3 is coupled to the second scan signal terminal GA2, a first electrode of the third transistor M3 is coupled to the third node N3, and a second electrode of the third transistor M3 is coupled to the first node N1.

In some embodiments, as shown in FIGS. 9A and 90, the first reset sub-circuit 5 includes a fourth transistor M4. A control electrode of the fourth transistor M4 is coupled to the first reset signal terminal RE1, a first electrode of the fourth transistor M4 is coupled to the initialization signal terminal Init, and a second electrode of the fourth transistor M4 is coupled to the first node N1.

In some embodiments, as shown in FIGS. 9A, 9B, and 90, the second reset sub-circuit 6 includes a fifth transistor M5. A control electrode of the fifth transistor M5 is connected to the second reset signal terminal RE2, a first electrode of the fifth transistor M5 is coupled to the initialization signal terminal Init, and a second electrode of the fifth transistor M5 is configured to be coupled to the first electrode of the light-emitting device L.

In some embodiments, as shown in FIGS. 9A to 9C, the first light-emitting control sub-circuit 7 includes a sixth transistor M6 and a seventh transistor M7. A control electrode of the sixth transistor M6 is coupled to the light-emitting control terminal EM, a first electrode of the sixth transistor M6 is coupled to the first voltage terminal Vdd, and a second electrode of the sixth transistor M6 is coupled to the driving sub-circuit 1. A control electrode of the seventh transistor M7 is coupled to the light-emitting control terminal EM, a first electrode of the seventh transistor M7 is coupled to the driving sub-circuit 1, and a second electrode of the seventh transistor M7 is configured to be coupled to the first electrode of the light-emitting device L.

In some examples, as shown in FIGS. 9A and 90, the second electrode of the sixth transistor M6 is coupled to the second node N2, the first electrode of the seventh transistor M7 is coupled to the third node N3. In some other examples, as shown in FIG. 9B, the second electrode of the sixth transistor M6 is coupled to the third node N3, the first electrode of the seventh transistor M7 is coupled to the second node N2.

In some embodiments, as shown in FIG. 9C, the second light-emitting control sub-circuit 8 includes an eighth transistor M8. A control electrode of the eighth transistor M8 is coupled to the light-emitting control terminal EM, a first electrode of the eighth transistor M8 is coupled to the first voltage terminal Vdd, and a second electrode of the eighth transistor M8 is coupled to the second terminal of the second capacitor Ccom.

In some embodiments, as shown in FIG. 9C, the third reset sub-circuit 9 includes a ninth transistor M9. A control electrode of the ninth transistor M9 is coupled to the third reset signal terminal REB, a first electrode of the ninth transistor M9 is coupled to the initialization signal terminal Init, and a second electrode of the ninth transistor M9 is coupled to the second terminal of the second capacitor Ccom.

In some embodiments, the third transistor M3 and/or the fourth transistor M4 are oxide thin film transistors, or a-Si thin film transistors. In this case, since a leakage current of the oxide thin film transistor or the a-Si thin film transistor is small, stability of the voltage stored in the first capacitor C in the storage sub-circuit 3 is improved. That is, stability of the voltage of the first node N1 is improved.

It will be noted that, the transistor used in the pixel circuit provided in the embodiments of the present disclosure may be a thin film transistor, a field effect transistor or other transistor having the same characteristics, and the embodiments of the present disclosure are described by taking the thin film transistors as an example.

In some embodiments, in the pixel circuit 201, the control electrode of the transistor is a gate of the transistor, the first electrode of the transistor is one of a source and a drain of the transistor, and the second electrode of the transistor is another one of the source and the drain of the transistor. Since the source and the drain of the transistor may be symmetrical in structure, there may be no difference in structure between the source and the drain. That is, the first electrode and the second electrode of the transistor in the embodiments of the present disclosure may be the same in structure. In a case where the transistor is a F-type transistor, the first electrode of the transistor is the source, and the second electrode is the drain. In a case where the transistor is an N-type transistor, the first electrode of the transistor is the drain, and the second electrode is the source.

In the pixel circuit 201 provided in the embodiments of the present disclosure, specific implementation manners of the sub-circuits (e.g., the driving sub-circuit 1, the data writing sub-circuit 2, the storage sub-circuit 3, the compensation sub-circuit 4, the first reset sub-circuit 5, the second reset sub-circuit 6, the first light-emitting control sub-circuit 7, the second light-emitting control sub-circuit 8 and the third reset sub-circuit 9) are not limited to the manners described above, and may be any implementation manner as used, such as a conventional connection manner well known to a person skilled in the art, as long as the realization of corresponding functions may be guaranteed. The above examples do not limit the protection scope of the present disclosure. In practical applications, a person skilled in the art may use or not to use one or more of the above sub-circuits according to situations. Variations and combinations based on the above sub-circuits do not depart from the principle of the present disclosure, and details are not be repeated herein.

In the pixel circuit 201 provided in some embodiments, nodes and terminals do not represent actual components, but represent junctions of relevant electrical connections in a circuit diagram That is, the node or the terminal is a node equivalent to the junction of relevant electrical connections in the circuit diagram.

In some example, each capacitor electrode of the capacitor may be a portion of a metal layer or a portion of a semiconductor layer (e.g., the semiconductor layer is made of a doped polysilicon).

An operation process of the pixel circuit 201 shown in FIG. 9C will be described below. For example, the third transistor M3, the fourth transistor M4, and the ninth transistor M9 are N-type transistors, and the first transistor M1, the second transistor M2, the fifth transistor M5, the sixth transistor M6, and the seventh transistor M7 and the eighth transistor M8 are P-type transistors. Referring to FIG. 10, in a frame period, an operating period of the pixel circuit 201 includes a reset period t1, a data writing period t2, and a light-emitting period t3.

As shown in FIGS. 9C and 10, in the reset period t1, the fourth transistor M4 in the first reset sub-circuit 5 is turned on in response to the first reset signal Reset1 at a high level received at the first reset signal terminal RE1, and transmits the initialization signal received at the initialization signal terminal Init to the control electrode of the first transistor M1. In this case, a voltage of the control electrode of the first transistor M1 is initialized, thereby preventing the residual signal of the previous frame from affecting the display effect of the current frame.

The ninth transistor M9 in the third reset sub-circuit 9 is turned on in response to the third reset signal Reset3 at a high level received at the third reset signal terminal RE3, and transmits the initialization signal received at the initialization signal terminal Init to the second electrode of the eighth transistor M8 and the second terminal of the second capacitor Ccom. In this case, a voltage of the second terminal of the eighth transistor M8 and a voltage of the second terminal of the second capacitor Ccom are initialized.

In the reset period t1, the second transistor M2, the third transistor M3, the fifth transistor M5, the sixth transistor M6, the seventh transistor M7, and the eighth transistor M8 are all in a turn-off state.

As shown in FIGS. 9C and 10, in the data writing period t2, the second transistor M2 in the data writing sub-circuit 2 is turned on in response to the first scan signal at a low level received at the first scan signal terminal GA1. The third transistor M3 in the compensation sub-circuit 3 is turned on in response to the second scan signal at a high level received at the second scan signal terminal GA2. In this case, the control electrode and the second electrode of the first transistor M1 in the driving sub-circuit 1 are electrically connected, so that the first transistor M1 is in a diode conducting state. The second transistor M2 writes the data signal recieved at the data signal terminal DA into the first electrode of the first transistor M1 (i.e., second node N2), the first transistor M1 transmits the data signal written into the second node N2 and a threshold voltage of the first transistor M1 to the second electrode of the first transistor M1 (i.e., third node N3), and the third transistor M3 writes the data signal and the threshold voltage into the the control electrode of the first transistor M1 (i.e., first node N1), so that the first capacitor(s) C in the storage sun-circuit 3 connected to the first node N1 are charged. In this case, the voltage V_{N1} of the first node N1 is equal to a sum of a voltage V_{data} of the data signal and the threshold voltage Vₜₕ, i.e., V_{N1}=V_{data}+Vₜₕ. Therefore, the pixel circuit 201 realizes the compensation of the threshold voltage of the first transistor M1.

It will be noted that, during the operation of the pixel circuit 201, if the first capacitor C in any second branch 32 is charged, the switching element T in the second branch 32 is in a turn-on state.

In this period, the fifth transistor M5 in the second reset sub-circuit 6 is turned on in response to the second reset signal Reset2 at a low level received at the second reset signal terminal RE2, and transmits the initialization signal at the initialization signal terminal Init to the first electrode of the light-emitting device L, so as to initialize the first electrode of the light-emitting device L, thereby preventing a residual signal from affecting light-emitting effect of the light-emitting device L.

In the data writing period t2, the fourth transistor M4, the sixth transistor M6, the seventh transistor M7, the eighth transistor M8, and the ninth transistor M9 are all in the turn-off state.

As shown in FIGS. 9C and 10, in the light-emitting period t3, the sixth transistor M6 and the seventh transistor M7 in the first light-emitting control sub-circuit 7 are turned on in response to the light-emitting control signal Em at a low level received at the light-emitting control terminal EM, so that the first transistor M1 in the driving sub-circuit 1 is conmunicated with the first voltage terminal Vdd and the light-emitting device L. In this case, the sixth transistor M6 transmits the first voltage of the first voltage terminal Vdd to the second node N2 (i.e., the source of the first transistor M1), and the light-emitting device L emits light according to a driving current (i.e., the driving signal) output by the first transistor M1, thereby achieving gray scale display.

In the light-emitting period t3, the eighth transistor M8 in the second light-emitting control sub-circuit 8 is also turned on in response to the light-emitting control signal Em at the low level received at the light-emitting control terminal EM, and writes the first voltage V_{DD} of the first voltage terminal Vdd into the first node N1. In this case, the voltage V′N_{I} of the first node N1 (i.e., the voltage V₀ of the control electrode of the first transistor M1) is equal to a sum of the voltage V_{data} of the data signal, the threshold voltage Vₜₕ and the first voltage V_{DD}, i.e., V′_{N1}=V_{g}=V_{data}+Vₜₕ+V_{DD}, and the voltage Vₛ of the source of the first transistor M1 is the first voltage V_{DD}. The voltage difference V_{gs}, between the control electrode (i.e., the gate) and source of the first transistor M1 is equal to V_{g} Vₛ, and the driving current I can be obtained by a following formula:

$$\begin{matrix}I = \frac{1}{2} μ {C}_{ox} \frac{W}{L} {( {V}_{gs} - {V}_{th} )}^{2} \\ = \frac{1}{2} μ {C}_{ox} \frac{W}{L} {( {V}_{data} + {V}_{th} + {V}_{DD} - {V}_{DD} - {V}_{th} )}^{2} \\ = \frac{1}{2} μ {C}_{ox} \frac{W}{L} {V}_{data}^{2}\end{matrix}$$

Here, W/L is a channel width-to-length ratio of the first transistor M1, C_{OX} is a dielectric constant of a channel insulating layer, and ρ is a channel carrier mobility.

It can be seen that the driving current I is only related to the structure of the first transistor M1 and the voltage of the data signal, and is unrelated to the threshold voltage of the first transistor M1 and the first voltage, By writing the first voltage into the first node N1 in the light-emitting period, influence of a voltage drop (i.e., IR drop) of the first voltage to the driving current may be avoided. Therefore, it is possible to avoid influence of the first voltage V_{DD} and the threshold voltage Vth on the driving current output by the driving sub-circuit 1, thereby ensuring accuracy of the displayed gray scale.

In the light-emitting period t3, the second transistor M2, the third transistor M3, the fourth transistor M4, the fifth transistor M5, and the ninth transistor M9 are all in the turn-off state.

In the light-emitting period t3, the charged first capacitor C in the storage sub-circuit 3 can maintain stability of the voltage of the control electrode (i.e., the gate voltage) of the first transistor M1, thereby ensuring stability of the driving signal provided to the light-emitting device L. Moreover, the second capacitor Ccom may ensure that the first voltage is stably written to the control electrode of the first transistor M1, and further ensure the stability of the driving signal provided to the light-emitting device L.

In a case where only the first capacitor C in the first branch 31 of the storage sub-circuit 3 is charged, since the third transistor M3 and the fourth transistor M4 have a leakage current, the voltage stored in the first capacitor C is influenced during the light-emitting period t3, resulting in a decrease in the voltage stored in the first capacitor C. Based on this, in order to reduce a change rate of the gate voltage of the first transistor M1 and ensure stablilty of light-emitting during the light-emitting period t3, the first capacitor C with a large capacitance may be selected. However, due to limitation of channel width-to-length ratios of the second transistor M2 and the third transistor M3 in the pixel circuit 201, a current flowing through the second transistor M2 and the third transistor M3 is limited, resulting an insufficient charging rate of the first capacitor C in the data writing periodt2. In this case, the data signal will not be completely written into the pixel circuit 201, which will cause deviation of a gray scale displayed by the light-emitting device L during the light-emitting period t3.

Moreover, in a case where the display panel 10 operates at a high refresh frequency (e.g., 90 Hz or 120 Hz), the first capacitor C with a small capacitance is required to ensure the charging rate; in a case where the display panel 10 operates at a low refresh frequency (e.g., 1 Hz or 10 Hz), the first capacitor C with a large capacitance is required to reduce the change rate of the gate voltage of the first transistor M1. As a result, if the first capacitor C with a large capacitance is selected, the charging rate thereof may be decreased; if the first capacitor C with a small capacitance is selected, the change rate of the gate voltage of the first transistor M1 may be increased.

Therefore, in the pixel circuit 201 provided in the embodiments of the present disclosure, for different refresh frequencies of the display panel 10, the number of first capacitors C that are connected in parallel in the storage sub-circuit 3 is adjusted by controlling the switching elements T in the storage sub-circuit 3 to be turned on or off, thereby obtaining a desired equivalent capacitance.

In a case where the pixel circuit 201 operates at a high refresh frequency, the equivalent capacitance of the storage sub-circuit 3 may be controlled to be small by controlling the number of switching elements T that are in the turn-on state, so as to improve the charging rate of the storage sub-circuit 3 during the data writing period is improved. In a case where the pixel circuit 201 operates at a low refresh frequency, the equivalent capacitance of the storage sub-circuit 3 may be controlled to be large by controlling the number of switching elements T that are in the turn-on state, so as to reduce the change rate of the gate voltage of the first transistor M1 In this way, it is possible to meet requirements for the charging rate of the storage sub-circuit 3 and the change rate of the gate voltage of the driving transistor (i.e., the first transistor M1) at different refresh frequencies, so that display effect of the display panel 10 at different refresh frequencies is improved. In addition, the display panel 10 has a low variation in brightness during low frequency display.

In some examples, as shown in FIG. 4, the storage sub-circuit 3 includes first capacitors C(0) and C(1), and the switching element T(1). The switching element T(1) is an N-type transistor. When the pixel circuit 201 operates at a high refresh frequency, the switching element T(1) may be in the turn-off state under control of the control signal at a low level at the control signal terminal CN(1). The equivalent capacitance of the storage sub-circuit 3 is the capacitance of the first capacitor C(0). In this case, the capacitance of the first capacitor C(0) may be a relatively small capacitance used for high frequency driving, such as 0.05 pF, thereby improving the charging rate of the data writing period. When the pixel circuit 201 operates at a low refresh frequency, the switching element T(1) is turned on in response to the control signal at a high level at the control signal terminal CN(1). In this case, the first capacitor C(1) and the first capacitor C(2) are connected in parallel, and the equivalent capacitance of the storage sub-circuit 3 is the sum of the capacitance of the first capacitor C(1) and the capacitance of the first capacitor C(2). since the capacitance of the storage sub-circuit 3 is relatively large, the change rate of the gate voltage of the first transistor M1 is relatively small when the display panel 10 displays at the low refresh frequency. In this way, the display panel 10 has a low variation in brightness.

FIG. 11A shows results of circuit simulation tests of pixel circuits in Example 1 and Example 2, at 120 Hz refresh frequency and a high gray scale. FIG. 11B shows results of circuit simulation tests of pixel circuits in Example 1 and Example 2, at 120 Hz refresh frequency and a low gray scale. FIG. 110 shows results of circuit simulation tests of pixel circuits in Example 1 and Example 2, at 1 Hz refresh frequency and a high gray scale. FIG. 11D shows results of circuit simulation tests of pixel circuits in Example 1 and Example 2, at 1 Hz refresh frequency and a low gray scale. In Example 1, the storage sub-circuit 3 in the pixel circuit 201 includes a first branch 31 and at least one second branch 32 (referring to FIG. 4). In Example 2, the storage sub-circuit 3 in the pixel circuit includes only the first branch 31. In the figures, “Normal (0.05p)” indicates that the capacitance of the storage sub-circuit 3 in the pixel circuit in Example 2 is 0.05 pF, “Normal design large Cst (0.1p)” indicates that the capacitance of the storage sub-circuit 3 in the pixel circuit in Example 2 is 0.1 pF, “New design (0.05p)” indicates that the capacitance of the storage sub-circuit 3 in the pixel circuit 201 in Example 1 is 0.05 pF, and “New design (0.1p)” indicates that the capacitance of the storage sub-circuit 3 in the pixel circuit 201 in Example 1 is 0.1 pF.

As shown in FIGS. 11A and 11B, when the pixel circuits operates at the high frequency (120 Hz), for the pixel circuit in Example 2, if the capacitance of the storage sub-circuit is 0.05 pF, the charging rate thereof is relatively high; if the capacitance of the storage sub-circuit is 0.1 pF, the charging rate thereof is reduced. For the pixel circuit in Example 1, since the equivalent capacitance of the storage sub-circuit 3 can be adjusted, it is ensured that the charging rate of the storage sub-circuit 3 is relatively high. For example, the equivalent capacitance of the storage sub-circuit is adjusted to 0.05 pF.

As shown in FIGS. 11C and 11D, when the pixel circuits operates at the low frequency (1 Hz), for the pixel circuit in Example 2, if the capacitance of the storage sub-circuit is 0.1 pF, the change rate of the gate voltage of the first transistor is low; if the capacitance of the storage sub-circuit is 0.05 pF, the change rate of the gate voltage of the first transistor is high. For the pixel circuit in Example 1, since the equivalent capacitance of the storage sub-circuit 3 can be adjusted, it is ensured that the change rate of the gate voltage of the first transistor is relatively low. For example, the equivalent capacitance of the storage sub-circuit is adjusted to 0.1 pF.

It can be seen that, the pixel circuit in Example 1 has a high charging rate similar to the charging rate of the pixel circuit with a small capacitance in Example 2 under the high frequency display, and has a low change rate of the gate voltage similar to the change rate of the pixel circuit with a large capacitance in Example 2 under the low frequency display. Therefore, the pixel circuit 201 provided in the embodiments of the present disclosure may ensure a good display effect under the high frequency and the low frequency.

Therefore, for different refresh frequencies of the display panel 10, it is possible to control the switching element T in the storage sub-circuit 3 to be turned on or off to adjust the number of the first capacitors C that are connected in parallel in the storage sub-circuit 3, thereby adjusting the magnitude of the capacitance of the storage sub-circuit 3, For example, the capacitance of the storage sub-circuit 3 corresponding to different refresh frequencies is different.

In some examples, as shown in FIG. 12, the storage sub-circuit 3 includes four first capacitors C(0), C(1), C(2) and C(3), and three switching elements T(1), T(2) and T(3). When the refresh frequency of the display panel 10 is in a range from 120 Hz to 90 Hz, the switching element T(1) is in the turn-off state under the control of the control signal of the control signal terminal CN(1), the switching element T(2) is in the turn-off state under the control of the control signal of the control signal terminal CN(2), and the switching element T(3) is in the turn-off state under the control of the control signal of the control signal terminal CN(3). In this case, the capacitance of the storage sub-circuit 3 is the capacitance of the first capacitor C(0). When the refresh frequency of the display panel 10 is in a range from 90 Hz to 60 Hz, the switching element T(1) is turned on in response to the control signal of the control signal terminal CN(1), the switching element T(2) is in the turn-off state under the control of the control signal of the control signal terminal CN(2), and the switching element T(3) is in the turn-off state under the control of the control signal of the control signal terminal CN(3). In this case, the first capacitor C(0) and the first capacitor C(1) are connected in parallel, and the equivalent capacitance of the storage sub-circuit 3 is a sum of capacitances of the first capacitor C(0) and the first capacitor C(1). When the refresh frequency of the display panel 10 is in a range from 60 Hz to 30 Hz, the switching element T(1) is turned on in response to the control signal of the control signal terminal CN(1), the switching element T(2) is turned on in response to the control signal of the control signal terminal CN(2), and the switching element T(3) is in the turn-off state under the control of the control signal of the control signal terminal CN(3). In this case, the first capacitor C(0), the first capacitor C(1) and the first capacitor C(2) are connected in parallel, and the equivalent capacitance of the storage sub-circuit 3 is a sum of capacitances of the first capacitor C(0), the first capacitor C(1) and the first capacitor C(2). When refresh frequency of the display panel 10 is in a range from 30 Hz to 1 Hz, the switching element T(1) is turned on in response to the control signal of the control signal terminal CN(1), the switching element T(2) is turned on in response to the control signal of the control signal terminal CN(2), and the switching element T(3) is turned on in response to the control signal of the control signal terminal CN(3). In this case, the first capacitor C(0), the first capacitor C(1), the first capacitor C(2) and the first capacitor C(3) are connected in parallel, and the equivalent capacitance of the storage sub-circuit 3 is a sum of capacitances of the first capacitor C(0), the first capacitor C(1), the first capacitor C(2) and the first capacitor C(3).

Therefore, under different refresh frequencies of the display panel 10, by controlling a parallel connection manner of the first capacitors C in the storage sub-circuit 3 in the pixel circuit 201, the capacitance of the storage sub-circuit 3 in the pixel circuit 201 may be accurately adjusted, thereby improving the display effect of the display panel 10.

In some embodiments, referring to FIGS. 1 and 2A, the display apparatus 01 further includes a controller 13. The controller 13 is coupled to the display panel 10. The controller 13 is configured to output control signal(s) to the control signal terminal(s) ON coupled to the switching element(s) T in the storage sub-circuit 3 in the pixel circuit 201 in the display panel 10 according to a refresh frequency of the display panel 10, so that the switching element T in the storage sub-circuit 3 is turned on and off.

For example, the controller 13 is a processor, a timing controller, or a driver IC.

In some embodiments, as shown in FIG. 1, the display apparatus 01 further includes a middle frame 11 and a housing 12. The display panel 10 and the housing 12 are located on two sides of the middle frame 11. A back face of the display panel 10 faces the housing 12. The display panel 10 and the housing 12 are fixed by the middle frame 11. The middle frame 11 includes a carrying board 110 and a frame 111 around the carrying board 110.

In some examples, referring to FIG. 1, the controller 13 is disposed on a side of the carrying board 110 facing the housing 12.

In other examples, referring to FIG. 2A, the control controller 13 is bonded to the display panel 10.

In some embodiments, referring to FIG. 2B, the display panel 10 includes a plurality of first gate lines GL and a plurality of data lines DL. The first gate line GL is configured to transmit the first scan signal, and the data line DL is configured to transmit the data signal. In this case, the first scan signal terminal GA1 is coupled to the first gate line DL, and the data signal terminal DA is coupled to the data line DL.

In some embodiments, the first scan signal terminal and the second scan signal terminal are coupled to the same gate line. In this case, the first scan signal and the second scan signal are the same.

In some embodiments, the display panel further includes a plurality of second gate lines. Second scan signal terminals corresponding to pixel circuits in a same row are coupled to the same second gate line. In this case, the first scan signal terminal and the second scan signal terminal are coupled to different gate lines, the first scan signal of the first scan signal terminal and the second scan signal of the second scan signal terminal may be different. For example, waveforms of the first scan signal and the second scan signal are the same but phases thereof are opposite.

For example, the plurality of first gate lines GL are coupled to a gate driver on array (GOA) circuit included in the display panel, and the plurality of second gate lines are coupled to another GOA circuit included in the display panel.

In some embodiments, the display panel further includes a plurality of control signal lines. In some examples, each control signal terminal coupled to the pixel circuit 201 is coupled to a respective one of the control signal lines. In this case, each switching element is turned on and off in response to the control signal transmitted by one control signal line. In some other examples, part of the control signal terminals coupled to the pixel circuit 201 are coupled to the same control signal line. In this case, switching elements coupled to the part of the control signal terminals are turned on and off in response to the control signal transmitted by the control signal line.

In some embodiments, the display panel further includes a plurality of first reset signal lines. First reset signal terminals corresponding to pixel circuits in a same row may be coupled to the same first reset signal line.

In some examples, the first reset signal terminal and the second reset signal terminal coupled to the pixel circuit 201 are coupled to the same reset signal line, or coupled to different reset signal lines. In other examples, the second reset signal terminal is also coupled to the first scan signal line coupled to the first scan signal terminal. In this case, the second reset signal and the first scan signal are the same.

In some embodiments, the first reset signal terminal and the third reset signal terminal are coupled to the same reset signal line. In this case, the first reset signal and the third reset signal are the same.

In some embodiments, the display panel further includes a plurality of light-emitting control lines. Light-emitting control terminals corresponding to pixel circuits in a same row may be coupled to the same light-emitting control line.

Some embodiments of the present disclosure provide a control method of a display apparatus. Referring to FIG. 2A, the display apparatus is the display apparatus 01 described in any of the above embodiments.

The control method of the display apparatus 01 includes: obtaining, by the controller 13, the refresh frequency of the display panel 10: outputing, by the controller 13, at least one control signal to at least one control signal terminal ON coupled to at least one switching element T in the storage sub-circuit 3, according to the refresh frequency of the display panel 10.

Different refresh frequencies correspond to different capacitances of the storage sub-circuit 3. For example, the controller 13 outputs two control signals to two control signal terminals ON according to the refresh frequency, so as to control two switching elements T to be turned on.

Beneficial effects of the control method of the display apparatus are the same as the beneficial effects of the pixel circuit described in any of the above embodiments, which are not described herein again.

The forgoing descriptions are merely specific implementations of the present disclosure, but the protection scope of the present disclosure is not limited thereto, and changes or replacements that a person skilled in the art could conceive of within the technical scope of the present disclosure shall be included in the protection scope of the present disclosure. Therefore, the protection scope of the present disclosure shall be subject to the protection scope of the claims.

What is claimed is:

1. A pixel circuit, comprising:
a data writing sub-circuit coupled to a first scan signal terminal, a data signal terminal and a second node, wherein the data writing sub-circuit is configured to write a data signal received at the data signal terminal into the second node, in response to a first scan signal received at the first scan signal terminal;
a driving sub-circuit coupled to a first node, the second node and a third node, wherein the driving sub-circuit is configured to transmit the data signal written into the second node and a compensation signal to the third node;
a compensation sub-circuit coupled to a second scan signal terminal, the first node and the third node, wherein the compensation sub-circuit is configured to write the data signal and the compensation signal into the first node, in response to a second scan signal recieved at the second scan signal terminal; and the driving sub-circuit is further configured to output a driving signal to a first electrode of a light-emitting device at least according to a voltage of the first node; and
a storage sub-circuit configured to store the data signal and the compensation signal that are written into the first node; wherein
the storage sub-circuit includes a plurality of first capacitors and at least one switching element; each switching element is coupled to at least two first capacitors, and the switching element is further coupled to a control signal terminal; and the switching element is configured to be turned on in response to a control signal received at the control signal terminal, so that the at least two first capacitors coupled to the switching element are connected in parallel.

2. The pixel circuit according to claim 1, wherein the storage sub-circuit includes a first branch and at least one second branch coupled to the first branch; the first branch includes a first capacitor, and each second branch includes another first capacitor and a switching element that are connected in series.

3. The pixel circuit according to claim 1, wherein the at least one second branch includes N second branches; a first second branch of the N second branches and the first branch are connected in parallel, and an i-th second branch and a first capacitor in an (i-1)-th second branch are connected in parallel; N and i are both integers, N is greater than or equal to 2, and i is greater than or equal to 2 and less than or equal to N; or
each second branch is connected in parallel with the first branch.

4. The pixel circuit according to claim 1, wherein the at least one switching element is an oxide thin film transistor or an a-Si thin film transistor.

5. The pixel circuit according to claim 1, wherein the driving sub-circuit includes a first transistor; a control electrode of the first transistor is coupled to the first node, a first electrode of the first transistor is coupled to the second node, and a second electrode of the first transistor is coupled to the third node.

6. The pixel circuit according to claim 1, wherein the data writing sub-circuit includes a second transistor; a control electrode of the second transistor is coupled to the first scan signal terminal, a first electrode of the second transistor is coupled to the data signal terminal, and a second electrode of the second transistor is coupled to the second node.

7. The pixel circuit according to claim 1, wherein the compensation sub-circuit includes a third transistor; a control electrode of the third transistor is coupled to the second scan signal terminal, a first electrode of the third transistor is coupled to the third node, and a second electrode of the third transistor is coupled to the first node.

8. The pixel circuit according to claim 1, further comprising a first reset sub-circuit coupled to a first reset signal terminal, an initialization signal terminal and the first node; wherein the first reset sub-circuit is configured to transmit an initialization signal received at the initialization signal terminal to the first node, in response to a first reset signal received at the first reset signal terminal.

9. The pixel circuit according to claim 8, wherein the first reset sub-circuit includes a fourth transistor; a control electrode of the fourth transistor is coupled to the first reset signal terminal, a first electrode of the fourth transistor is coupled to the initialization signal terminal, and a second electrode of the fourth transistor is coupled to the first node.

10. The pixel circuit according to claim 8, further comprising a second reset sub-circuit coupled to a second reset signal terminal and the initialization signal terminal; wherein
the second reset sub-circuit is configured to be coupled to the first electrode of the light-emitting device, and is further configured to transmit the initialization signal received at the initialization signal terminal to the first electrode of the light-emitting device, in response to a second reset signal received at the second reset signal terminal.

11. The pixel circuit according to claim 10, wherein the second reset sub-circuit includes a fifth transistor; a control electrode of the fifth transistor is coupled to the second reset signal terminal, a first electrode of the fifth transistor is coupled to the initialization signal terminal, and a second electrode of the fifth transistor is configured to be coupled to the first electrode of the light-emitting device.

12. The pixel circuit according to claim 1, further comprising a first light-emitting control sub-circuit coupled to a light-emitting control terminal, the first voltage terminal and the driving sub-circuit; wherein
the first light-emitting control sub-circuit is configured to be coupled to the first electrode of the light-emitting device, and is further configured to be turned on in response to a light-emitting control signal received at the light-emitting control terminal, so that the driving sub-circuit is communicated with the first voltage terminal and the first electrode of the light emitting device.

13. The pixel circuit according to claim 12, wherein the first light-emitting control sub-circuit includes:
a sixth transistor, wherein a control electrode of the sixth transistor is coupled to the light-emitting control terminal, a first electrode of the sixth transistor is coupled to the first voltage terminal, and a second electrode of the sixth transistor is coupled to the driving sub-circuit; and
a seventh transistor, wherein a control electrode of the seventh transistor is coupled to the light-emitting control terminal, a first electrode of the seventh transistor is coupled to the driving sub-circuit, and a second electrode of the seventh transistor is configured to be coupled to the light-emitting device.

14. The pixel circuit according to claim 12, further comprising a second light-emitting control sub-circuit and a second capacitor; wherein
a first terminal of the second capacitor is coupled to the first node, and a second terminal of the second capacitor is coupled to the second light-emitting control sub-circuit; and
the second light-emitting control sub-circuit is further coupled to the first voltage terminal and the light-emitting control terminal; and the second light-emitting control sub-circuit is configured to transmit the first voltage of the first voltage terminal to the second terminal of the second capacitor, in response to the light-emitting control signal received at the light-emitting control terminal.

15. The pixel circuit according to claim 14, wherein the second light-emitting control sub-circuit includes an eighth transistor; a control electrode of the eighth transistor is coupled to the light-emitting control terminal, a first electrode of the eighth transistor is coupled to the first voltage terminal, and a second electrode of the eighth transistor is coupled to the second terminal of the second capacitor.

16. The pixel circuit according to claim 14, further comprising a third reset sub-circuit coupled to a third reset signal terminal, an initialization signal terminal and the second terminal of the second capacitor; wherein the third reset sub-circuit is configured to transmit an initialization signal received at the initialization signal terminal to the second terminal of the second capacitor, in response to a third reset signal received at the third reset signal terminal.

17. The pixel circuit according to claim 7, wherein the third reset sub-circuit includes a ninth transistor; a control electrode of the ninth transistor is coupled to the third reset signal terminal, a first electrode of the ninth transistor is coupled to the initialization signal terminal, and a second electrode of the ninth transistor is coupled to the second terminal of the second capacitor.

18. A display panel, comprising:
a plurality of pixel circuits according to claim 1; and
a plurality of light-emitting devices; wherein
a first electrode of a light-emitting device of the plurality of light-emitting devices is coupled to the pixel circuit, and a second electrode of the light-emitting device is coupled to a second voltage terminal.

19. A display apparatus, comprising:
the display panel according to claim 18; and
a controller coupled to the display panel, wherein the controller is configured to output at least one control signal to at least one control signal terminal coupled to the at least one switching element in the storage sub-circuit in the pixel circuit according to a refresh frequency of the display panel, so as to control the at least one switching element in the storage sub-circuit to be turned on and off.

20. A control method of a display apparatus, the display apparatus being the display apparatus according to claim 19, and the control method comprising:
obtaining, by the controller, the refresh frequency of the display panel; and
outputing, by the controller the at least one control signal to the at least one control signal terminal coupled to the at least one switching element in the storage sub-circuit, according to the refresh frequency of the display panel.
